(19) United States
(12) Patent Application Publication
(10) Pub. No.: US 2024/0028076 A1
(43) Pub. Date: Jan. 25, 2024

(54) ELECTRONIC SYSTEM AND ELECTRONIC DEVICE WITH EXPANSION FUNCTION

(71) Applicant: Primax Electronics Ltd., Taipei (TW)

(72) Inventors: Chuan-Tai Hsiao, Taipei (TW); Chun-Han Huang, Taipei (TW); Tse-Ping Kuan, Taipei (TW); Hung-Wei Kuo, Taipei (TW)

(21) Appl. No.: 17/884,332

(22) Filed: Aug. 9, 2022

(30) Foreign Application Priority Data
Jul. 21, 2022 (TW) 111127347

(51) Int. Cl. G06F 1/16

(52) U.S. Cl. CPC G06F 1/1632

(57) ABSTRACT

An electronic system with an expansion system is provided. The electronic system includes plural electronic devices. Each electronic device includes plural connecting interfaces. The plural electronic devices are combined together through the plural connecting interfaces.

### FIELD OF THE INVENTION

The present invention relates to an electronic system, and more particularly to an electronic system integrating plural electronic devices.

### BACKGROUND OF THE INVENTION

With increasing development of science and technology, computer devices become essential tools in homes or workplaces. In order to improve the working efficiency of desktop computers, many users usually use plural display screens or plural different input devices at the same time. For example, the input devices include mouse devices, keyboards, touchpads, handwriting boards, or the like. In some situations, the user has to transmit data from a smart phone, a tablet computer or an external hard drive to the hard drive of a desktop computer in a wired transmission manner.

Generally, the number of connecting ports in the desktop computer host or the notebook computer is limited. For allowing the desktop computer host or the notebook computer to be connected with more display screens and more input devices, the desktop computer host or the notebook computer is additionally equipped with an expansion device with plural connecting ports. Moreover, the desktop computer host or the notebook computer can be in communication with the smart phone or the tablet computer to exchange data through the expansion device. However, the number of connecting ports in the single expansion device is still limited.

For solving the above drawbacks, it is important to provide an electronic system with increased number of connecting ports.

### SUMMARY OF THE INVENTION

The present invention provides an electronic system and an electronic device with an expansion function.

In accordance with an aspect of the present invention, an electronic device with an expansion function, the electronic device is provided. The electronic device includes plural connecting interfaces, plural output multiplexers, a USB hub and a processor. The plural output multiplexers are electrically connected with the plural connecting interfaces, respectively. The USB hub is electrically connected with the plural output multiplexers. The processor is electrically connected with the plural output multiplexers and the USB hub. When one of the plural connecting interfaces is connected with a host terminal, the processor judges that the connecting interface connected with the host terminal is a host port and the other connecting interfaces are slave ports through the USB hub, and the processor switches voltage levels of the plural connecting interfaces through the plural output multiplexers.

In an embodiment, the processor includes a first transmission interface and a second transmission interface.

In an embodiment, the first transmission interface is electrically connected with the USB hub, and the first transmission interface is an inter-integrated circuit (I²C) transmission interface.

In an embodiment, the second transmission interface is electrically connected with the plural output multiplexers, and the second transmission interface is a general-purpose input/output (GPIO) transmission interface.

In an embodiment, each of the plural connecting interfaces includes a USB data positive signal pin and a USB data negative signal pin.

In accordance with another aspect of the present invention, an electronic system with an expansion function is provided. The electronic system includes plural electronic devices. Each of the plural electronic devices includes plural connecting interfaces, plural output multiplexers, a USB hub and a processor. Each of the plural electronic devices is combined with other electronic devices through the plural connecting interfaces. The plural output multiplexers are electrically connected with the plural connecting interfaces, respectively. The USB hub is electrically connected with the plural output multiplexers. The processor is electrically connected with the plural output multiplexers and the USB hub. When one of the plural connecting interfaces of a first electronic device of the plural electronic devices is connected with a host terminal, the processor of the first electronic device judges that the connecting interface of the first electronic device connected with the host terminal is a host port and the other connecting interfaces of the first electronic device are slave ports through the USB hub of the first electronic device. A second electronic device and a third electronic device of the plural electronic devices are combined with the first electronic device through the other connecting interfaces of the first electronic device. When a fourth electronic device of the plural electronic devices is combined with both of the second electronic device and the third electronic device, the host terminal judges a hierarchical relationship between the fourth electronic device and the second and third electronic devices through the USB hub, so that the fourth electronic device is connected with the second electronic device or the third electronic device to match.

In an embodiment, the processor includes a first transmission interface and a second transmission interface.

In an embodiment, the first transmission interface is electrically connected with the USB hub, and the first transmission interface is an inter-integrated circuit (I²C) transmission interface.

In an embodiment, the second transmission interface is electrically connected with the plural output multiplexers, and the second transmission interface is a general-purpose input/output (GPIO) transmission interface.

In an embodiment, each of the plural connecting interfaces includes a USB data positive signal pin and a USB data negative signal pin.

In an embodiment, each of the plural electronic devices, the processor switches voltage levels of the plural connecting interfaces through the plural output multiplexers.

From the above descriptions, the present invention provides an electronic system with plural electronic devices. Each electronic device comprises plural connecting interfaces. The plural electronic devices are combined together and connected to match. Consequently, more input ports and more output ports are provided to be used by the user.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating the architecture of an electronic device with an expansion function; and

FIG. 2 is a schematic block diagram illustrating the architecture of an electronic system with an expansion function according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

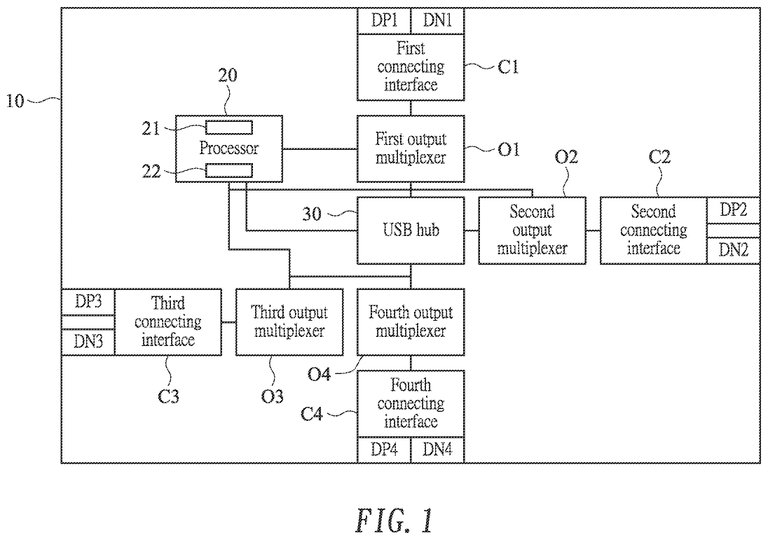

Please refer to FIG. 1. FIG. 1 is a schematic block diagram illustrating the architecture of an electronic device with an expansion function. For clarification, the electronic device with the expansion function is referred to as a first electronic device 10. The first electronic device 10 comprises a processor 20, a USB hub 30, plural output multiplexers and plural connecting interfaces.

In this embodiment, the first electronic device 10 comprises four output multiplexers and four connecting interfaces. The four output multiplexers include a first output multiplexer O1, a second output multiplexer O2, a third output multiplexer O3 and a fourth output multiplexer O4. The four connecting interfaces include a first connecting interface C1, a second connecting interface C2, a third connecting interface C3 and a fourth connecting interface C4. The connecting interfaces C1, C2, C3 and C4 can be used as connecting ports to be connected with other identical or different electronic devices. The first connecting interface C1 comprises a USB data positive signal pin DP1 and a USB data negative signal pin DN1. The second connecting interface C2 comprises a USB data positive signal pin DP2 and a USB data negative signal pin DN2. The third connecting interface C3 comprises a USB data positive signal pin DP3 and a USB data negative signal pin DN3. The fourth connecting interface C4 comprises a USB data positive signal pin DP4 and a USB data negative signal pin DN4.

The USB hub 30 is electrically connected with the first output multiplexer O1, the second output multiplexer O2, the third output multiplexer O3 and the fourth output multiplexer O4. The first output multiplexer O1, the second output multiplexer O2, the third output multiplexer O3 and the fourth output multiplexer O4 are further connected with the first connecting interface C1, the second connecting interface C2, the third connecting interface C3 and the fourth connecting interface C4, respectively.

The processor 20 is electrically connected with the first output multiplexer O1, the second output multiplexer O2, the third output multiplexer O3, the fourth output multiplexer O4 and the USB hub 30.

In an embodiment, the processor 20 comprises a first transmission interface 21 and a second transmission interface 22. The first transmission interface 21 is an inter-integrated circuit (I²C) transmission interface. The processor 20 is electrically connected with the USB hub 30 through the first transmission interface 21. The second transmission interface 22 is a general-purpose input/output (GPIO) transmission interface. Moreover, the processor 20 is electrically connected with the first output multiplexer O1, the second output multiplexer O2, the third output multiplexer O3 and the fourth output multiplexer O4 through the second transmission interface 22.

When the first electronic device 10 is connected with other electronic devices through the first connecting interface C1, the second connecting interface C2, the third connecting interface C3 and the fourth connecting interface C4, the processor 20 judges the first connecting interface C1, the second connecting interface C2, the third connecting interface C3 and the fourth connecting interface C4 through the USB hub 30. According to the judging results, the processor 20 determines these connecting interfaces C1˜C4 are host ports or slave ports. Moreover, the processor 20 switches the voltage levels of the first connecting interface C1, the second connecting interface C2, the third connecting interface C3 and the fourth connecting interface C4 through the first output multiplexer O1, the second output multiplexer O2, the third output multiplexer O3 and the fourth output multiplexer O4. Moreover, the vendor IDs (VID) and the product identification codes (PID) of the electronic devices combined with the first electronic device 10 can be inquired and identified through the USB data positive signal pin (D+) DP1˜DP4 and the USB data negative signal pin (D−) DN1˜DN4 of the connecting interfaces C1˜C4. According to the vendor IDs (VID) and the product identification codes (PID), the hierarchical relationship between the corresponding electronic devices can be judged and the necessity of connecting with the corresponding electronic devices can be determined.

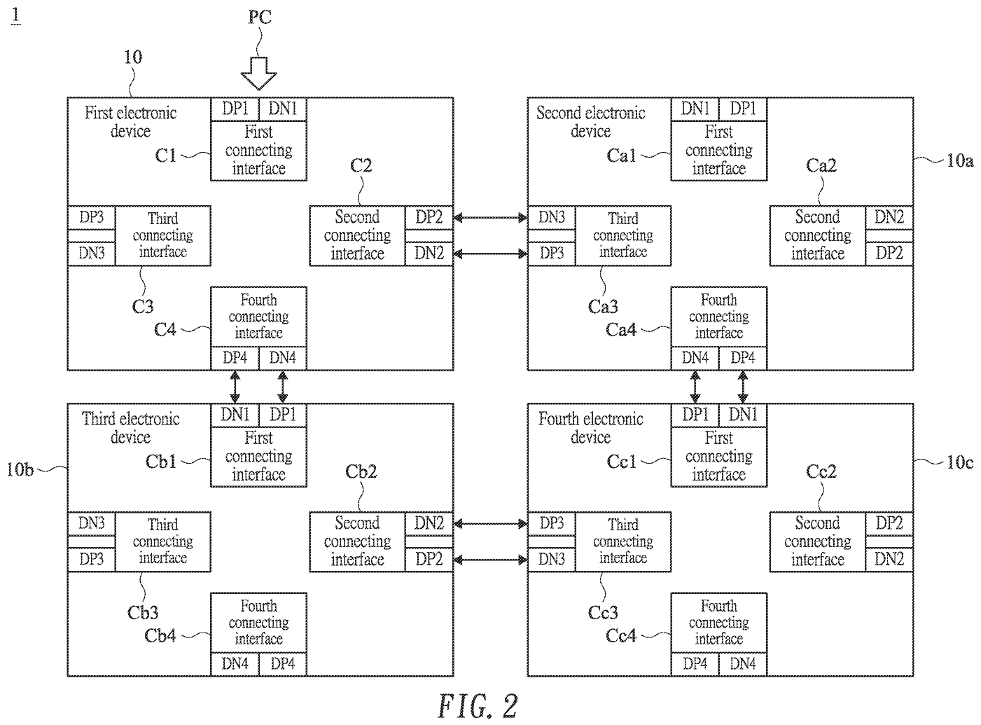

Please refer to FIGS. 1 and 2. FIG. 2 is a schematic block diagram illustrating the architecture of an electronic system with an expansion function according to an embodiment of the present invention. The electronic system 1 with the expansion function comprises plural electronic devices that can be combined with each other. In this embodiment, the plural electronic devices comprise four electronic devices. The four electronic devices comprise a first electronic device 10, a second electronic device 10a, a third electronic device 10b and a fourth electronic device 10c. Similarly, the second electronic device 10a comprises a processor (not shown), a USB hub (not shown), plural output multiplexers (not shown) and four connecting interfaces Ca1˜Ca4. Similarly, the third electronic device 10b comprises a processor (not shown), a USB hub (not shown), plural output multiplexers (not shown) and four connecting interfaces Cb1˜Cb4. Similarly, the fourth electronic device 10c comprises a processor (not shown), a USB hub (not shown), plural output multiplexers (not shown) and four connecting interfaces Cc1˜Cc4. The functions and structures of the processors, the USB hubs, the output multiplexers and the connecting interfaces of the second electronic device 10a, the third electronic device 10b and the fourth electronic device 10c are similar to those of the processor 20, the USB hub 30, the output multiplexers O1-O4 and the connecting interfaces C1˜C4 of the first electronic device 10, and not redundantly described herein. Moreover, the first electronic device 10, the second electronic device 10a, the third electronic device 10b and the fourth electronic device 10c can be combined with each other through the connecting interfaces C1˜C4, Ca1˜Ca4, Cb1˜Cb4 and Cc1˜Cc4.

In this embodiment, the first electronic device 10 is connected with a host terminal PC such as a notebook computer or a desktop computer. When the first connecting interface C1 of the first electronic device 10 is connected with the host terminal PC, the processor 20 judges that the first connecting interface C1 connected with the host terminal PC is host port through the USB hub 30. In addition, the processor 20 judges that the other connecting interfaces C2, C3 and C4 are slave ports through the USB hub 30. The third connecting interface Ca3 of the second electronic device 10a is connected with the second connecting interface C2 of the first electronic device 10. Consequently, the second electronic device 10a is combined with the first electronic device 10. The first connecting interface Cb1 of the third electronic device 10b is connected with the fourth connecting interface C4 of the first electronic device 10. Consequently, the third electronic device 10b is combined with the first electronic device 10.

The host terminal PC can inquire and identify the vendor IDs and the product identification codes of the second electronic device 10a and the third electronic device 10b through the USB hub 30. According to the vendor IDs and the product identification codes, the processor 20 of the first electronic device 10 switches the voltage levels of the second connecting interface C2 and the fourth connecting interface C4 through the second output multiplexer O2 and the fourth output multiplexer O4. Consequently, corresponding voltages signals (e.g., high voltage signals or low voltage signals) are transmitted to the second electronic device 10a and the third electronic device 10b through the second connecting interface C2 and the fourth connecting interface C4.

Then, the fourth electronic device 10c is connected with the fourth connecting interface Ca4 of the second electronic device 10a through the first connecting interface Cc1, and the fourth electronic device 10c is connected with the second connecting interface Cb2 of the third electronic device 10b through the third connecting interface Cc3. Meanwhile, the host terminal PC can inquire and identify the vendor ID and the product identification code of the fourth electronic device 10c through the USB hub 30. According to the vendor ID and the product identification code, the host terminal PC judges a hierarchical relationship between the fourth electronic device 10c and the electronic devices 10a and 10b. Consequently, the fourth electronic device 10c is selectively connected with the second electronic device 10a and the third electronic device 10b to match.

From the above descriptions, the present invention provides an electronic system with plural electronic devices. Each electronic device comprises plural connecting interfaces. The plural electronic devices are combined together and connected to match. Consequently, more input ports and more output ports are provided to be used by the user. In other words, the electronic system of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An electronic device with an expansion function, the electronic device comprising:
plural connecting interfaces;
plural output multiplexers electrically connected with the plural connecting interfaces, respectively;
a USB hub electrically connected with the plural output multiplexers; and
a processor electrically connected with the plural output multiplexers and the USB hub,
wherein when one of the plural connecting interfaces is connected with a host terminal, the processor judges that the connecting interface connected with the host terminal is a host port and the other connecting interfaces are slave ports through the USB hub, and the processor switches voltage levels of the plural connecting interfaces through the plural output multiplexers.

2. The electronic device according to claim 1, wherein the processor comprises a first transmission interface and a second transmission interface.

3. The electronic device according to claim 2, wherein the first transmission interface is electrically connected with the USB hub, and the first transmission interface is an inter-integrated circuit (I²C) transmission interface.

4. The electronic device according to claim 2, wherein the second transmission interface is electrically connected with the plural output multiplexers, and the second transmission interface is a general-purpose input/output (GPIO) transmission interface.

5. The electronic device according to claim 1, wherein each of the plural connecting interfaces comprises a USB data positive signal pin and a USB data negative signal pin.

6. An electronic system with an expansion function, the electronic system comprising plural electronic devices, each of the plural electronic devices comprising:
plural connecting interfaces, wherein each of the plural electronic devices is combined with other electronic devices through the plural connecting interfaces;
plural output multiplexers electrically connected with the plural connecting interfaces, respectively;
a USB hub electrically connected with the plural output multiplexers; and
a processor electrically connected with the plural output multiplexers and the USB hub,
wherein when one of the plural connecting interfaces of a first electronic device of the plural electronic devices is connected with a host terminal, the processor of the first electronic device judges that the connecting interface of the first electronic device connected with the host terminal is a host port and the other connecting interfaces of the first electronic device are slave ports through the USB hub of the first electronic device,
wherein a second electronic device and a third electronic device of the plural electronic devices are combined with the first electronic device through the other connecting interfaces of the first electronic device,
wherein when a fourth electronic device of the plural electronic devices is combined with both of the second electronic device and the third electronic device, the host terminal judges a hierarchical relationship between the fourth electronic device and the second and third electronic devices through the USB hub, so that the fourth electronic device is connected with the second electronic device or the third electronic device to match.

7. The electronic system according to claim 6, wherein the processor comprises a first transmission interface and a second transmission interface.

8. The electronic system according to claim 7, wherein the first transmission interface is electrically connected with the USB hub, and the first transmission interface is an inter-integrated circuit (FC) transmission interface.

9. The electronic system according to claim 7, wherein the second transmission interface is electrically connected with the plural output multiplexers, and the second transmission interface is a general-purpose input/output (GPIO) transmission interface.

10. The electronic system according to claim 6, wherein each of the plural connecting interfaces comprises a USB data positive signal pin and a USB data negative signal pin.

11. The electronic system according to claim 6, wherein in each of the plural electronic devices, the processor switches voltage levels of the plural connecting interfaces through the plural output multiplexers.
